(19) United States
(12) Patent Application Publication
(10) Pub. No.: US 2019/0006101 A1
(43) Pub. Date: Jan. 3, 2019

(54) ELECTRONIC COMPONENT HOLDER

(71) Applicant: KYB Corporation, Tokyo (JP)

(72) Inventors: Tarou MATSUMAE, Tokyo (JP); Satoshi TAKEUCHI, Tokyo (JP); Kenji KONDA, Kanagawa (JP)

(73) Assignee: KYB Corporation, Tokyo (JP)

(21) Appl. No.: 16/064,250

(22) PCT Filed: Nov. 4, 2016
(86) PCT No.: PCT/JP2016/082854

§ 371 Date: Jun. 20, 2018

(30) Foreign Application Priority Data
Dec. 25, 2015 (JP) 2015-254439

(51) Int. Cl. H01G 2/04; H01G 9/008

(52) U.S. Cl. CPC H01G 2/04; H01G 9/008

(57) ABSTRACT

An electronic component holder 100 for holding a cylindrical electrolytic capacitors 5 provided in an electronic control device 10 includes a clip portion 11 that is formed to be capable of expanding and contracting and accommodates the electrolytic capacitor 5 while gripping the outer peripheral surface 5A of the electrolytic capacitor 5, and a restricting portion 30 that is latched to the clip portion 11 to prevent the clip portion 11 from separating from the outer peripheral surface 5A of the electrolytic capacitor 5.

### TECHNICAL FIELD

The present invention relates to an electronic component holder.

### BACKGROUND ART

Conventionally, a cylindrical electronic component is mounted in an electronic control device. JP2010-35304A discloses a configuration in which a cylindrical capacitor connected to a terminal is mounted on an electronic circuit board.

### SUMMARY OF INVENTION

A cylindrical electronic component mounted in an electronic control device may exhibit poor adhesiveness such that an outer peripheral surface thereof cannot easily be adhered using an adhesive. As a method of fixing this type of electronic component, the electronic component may be fixed by coating a connection terminal of the electronic component with an adhesive, for example.

However, in a method of fixing the connection terminal, a main body part of the electronic component is not restrained, and therefore, when vibration or the like is input, the main body part may vibrate using the fixed connection terminal as a fulcrum. When the electronic component main body vibrates in this manner, the connection terminal may bend, leading to a reduction in the durability of the connection terminal.

An object of the present invention is to fix an electronic component provided in an electronic control device more reliably.

According to one aspect of the present invention, an electronic component holder for holding a cylindrical electronic component provided in an electronic control device, includes a clip portion that is formed to be capable of expanding and contracting and accommodates the electronic component while gripping an outer peripheral surface of the electronic component; and a restricting portion that is latched to the clip portion to prevent the clip portion from separating from the outer peripheral surface of the electronic component.

### BRIEF DESCRIPTION OF DRAWINGS

FIG. 1 is an exploded perspective view showing an electronic control device according to an embodiment of the present invention in a condition prior to assembly of a bus bar unit and a terminal guide.

FIG. 2 is a perspective view showing a condition in which an electrolytic capacitor is attached to a clip portion of an electronic component holder according to this embodiment of the present invention.

FIG. 3 is a perspective view showing the clip portion and a restricting portion of the electronic component holder according to this embodiment of the present invention.

FIG. 4 is a sectional view taken along an A-A line in FIG. 3.

FIG. 5 is a perspective view showing the restricting portion according to this embodiment of the present invention.

FIG. 6 is a sectional view taken along a B-B line in FIG. 3.

FIG. 7 is a sectional view showing a procedure for assembling the electronic component holder according to this embodiment of the present invention, and a view showing a process for attaching the electrolytic capacitor to the clip portion.

FIG. 8 is a sectional view showing a procedure for assembling the electronic component holder according to this embodiment of the present invention, and a view showing a process for latching the restricting portion to the clip portion.

### DESCRIPTION OF EMBODIMENTS

An electronic component holder 100 according to an embodiment of the present invention will be described below with reference to the figures.

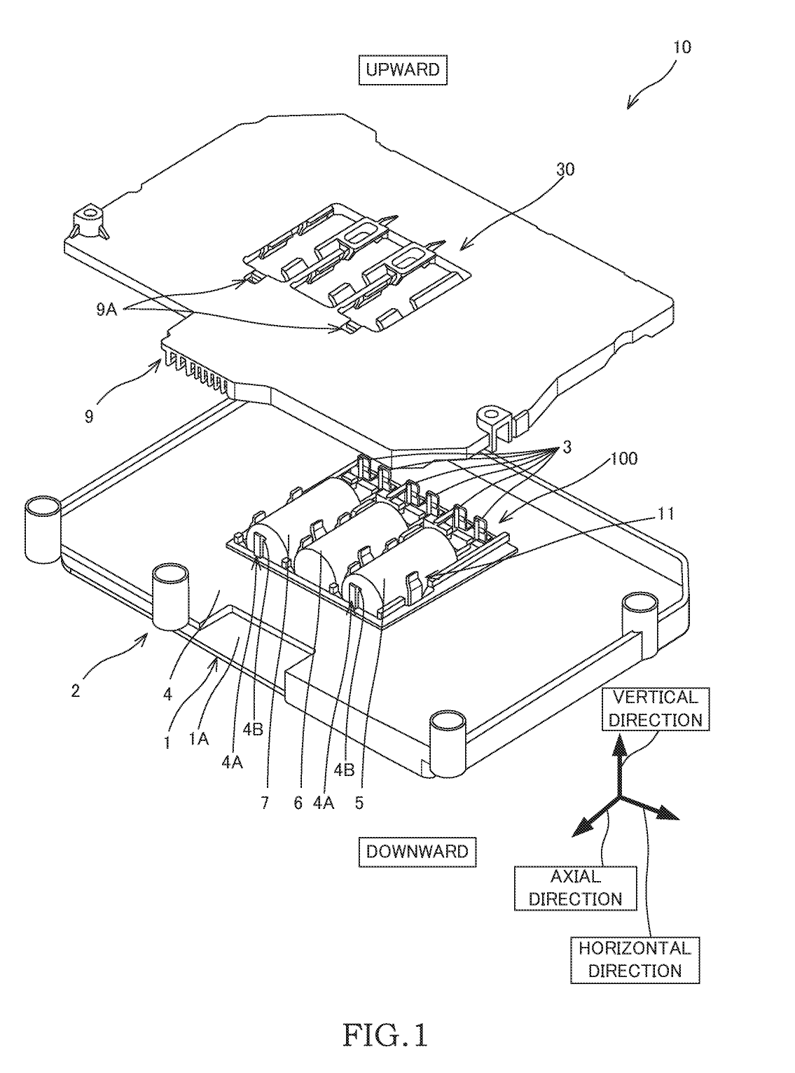

The electronic component holder 100 is used in an electronic control device 10 that includes a pair of electronic substrates. As shown in FIG. 1, the electronic control device 10 includes a power supply substrate 1 that serves as an electronic substrate for controlling a power supply supplied to a control subject (not shown), and a control substrate (not shown) that serves as an electronic substrate for controlling the control subject by transmitting and receiving control signals. The electronic component holder 100 holds a cylindrical electronic component mounted on a bus bar unit 2 that is attached to the power supply substrate 1.

The electronic control device 10 is an ECU (Engine Control Unit) that controls an engine of a vehicle as the control subject, an ECU (Electronic Control Unit) that controls an electric power steering device as the control subject, or the like, for example.

The power supply substrate 1 is a flat plate-shaped printed board formed from a metal that exhibits superior heat dissipation, such as aluminium. The power supply substrate 1 is formed in a substantially rectangular shape, and an electronic circuit is formed on a front surface 1A thereof. The bus bar unit 2 on which the electronic component is mounted is attached to the power supply substrate. The bus bar unit 2 electrically connects the power supply substrate 1 and the control substrate to each other.

As shown in FIG. 1, the bus bar unit 2 includes a plurality of terminals (bus bars) 3, and a covering portion 4 that holds the plurality of terminals 3 together on the power supply substrate 1. The covering portion 4 is formed by molding the plurality of terminals 3 using a resin material. The resin material is an insulating material that insulates the plurality of terminals 3 from each other. It should be noted that for convenience, FIG. 1 shows only the terminals 3 to which leads 8 of electrolytic capacitors 5, 6, 7, to be described below, are connected, and the other terminals are not shown.

The electrolytic capacitors 5, 6, 7, which are cylindrical electronic components that adjust a voltage to a fixed level by removing noise, are mounted on the front surface of the bus bar unit 2 together with other electronic components (not shown).

In the electronic control device 10, the three electrolytic capacitors 5, 6, 7 are mounted on the bus bar unit 2 such that respective central axes thereof are arranged substantially parallel to each other. The electrolytic capacitors 5, 6, 7 are provided such that the central axes thereof are substantially parallel to, i.e. not inclined relative to, the front surface of the bus bar unit 2.

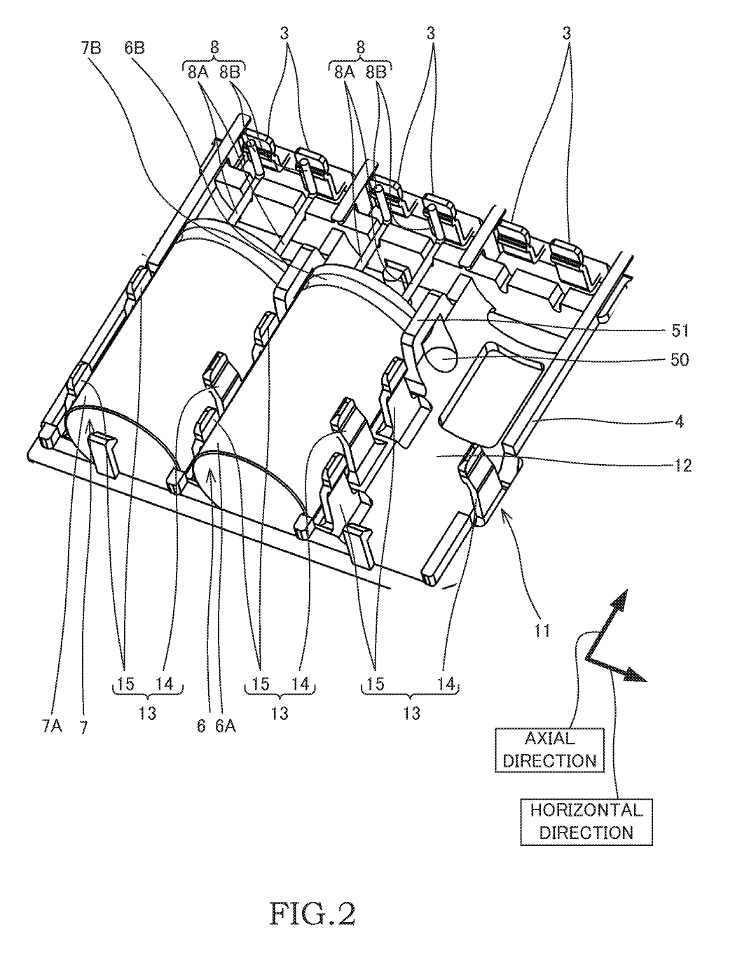

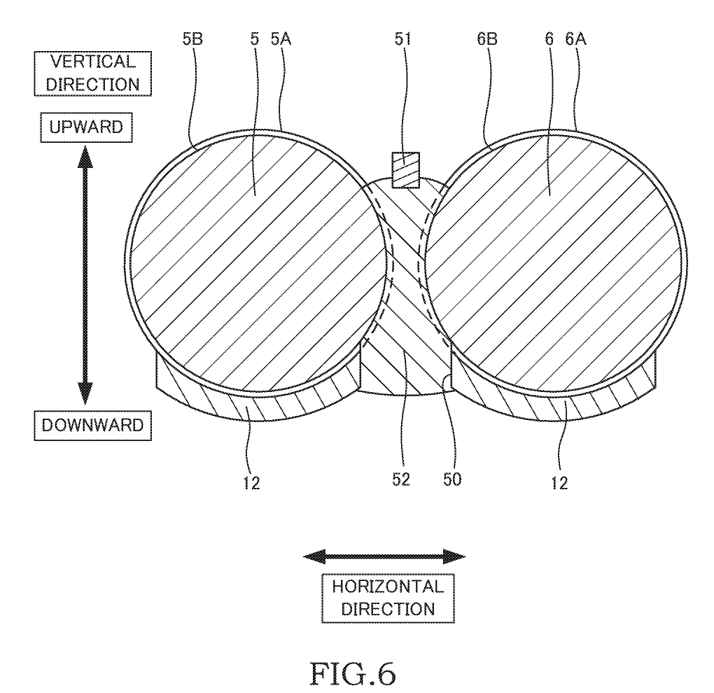

As shown in FIG. 2, each of the electrolytic capacitors 5, 6, 7 is provided with a pair of leads 8 projecting from one end surface thereof. Each of the pair of leads 8 includes a parallel portion 8A extending in a central axis direction (i.e. extending substantially parallel to the central axis) from one end surface of the electrolytic capacitors 5, 6, 7, and a perpendicular portion 8B that bends from the parallel portion 8A so as to extend in a direction perpendicular to the central axis. The perpendicular portions 8B of the respective pairs of leads 8 are electrically connected to the terminals 3. Further, indented portions 5B, 6B, 7B formed as annular indentations are formed respectively in outer peripheral surfaces 5A, 6A, 7A of the electrolytic capacitors 5, 6, 7 (see FIGS. 2 and 6). It should be noted that in FIG. 2, the electrolytic capacitor 5 is omitted, and only the electrolytic capacitors 6 and 7 are shown. Furthermore, the indented portions 5B, 6B, 7B are not limited to an annular shape, and may be formed in a circumferential direction part of the outer peripheral surfaces 5A, 6A, 7A.

A terminal guide 9 shown in FIG. 1 is attached to the bus bar unit 2. The bus bar unit 2 and the terminal guide 9 are fixed to each other such that detachment is restricted by hook portions 4A provided on the bus bar unit 2 as fixing portions. More specifically, the hook portions 4A are provided respectively in positions opposing bottom surfaces of the electrolytic capacitor 5 and the electrolytic capacitor 7 held on the bus bar unit 2, and are inserted through hook holes 9A formed in corresponding positions in the terminal guide 9. Hook pawls 4B formed on respective tip ends of the hook portions 4A are thus engaged to the terminal guide 9 so as to prevent the bus bar unit 2 and the terminal guide 9 from becoming detached in response to a disturbance such as vibration, and as a result, the bus bar unit 2 and the terminal guide 9 are fixed to each other.

The terminal guide 9 is provided between the power supply substrate 1 and the control substrate, and when attached to the bus bar unit 2, defines the position of a terminal, not shown in the figures, using a guide hole (not shown) so that the terminal can be connected to the control substrate. The terminal guide 9 is a substantially flat plate-shaped resin member having a front surface that faces the control substrate and a rear surface that faces the bus bar unit 2.

The electronic component holder 100 holds the three electrolytic capacitors 5, 6, 7 mounted in the bus bar unit 2 so as to fix the electrolytic capacitors 5, 6, 7 to the bus bar unit 2. A configuration of the electronic component holder 100 will be described in detail below with reference to FIGS. 1 to 6. It should be noted that in the following description, for convenience, as shown in FIG. 1, a direction in which the central axes of the electrolytic capacitors 5, 6, 7 extend will be referred to as an “axial direction”, a direction in which the electrolytic capacitors 5, 6, 7 are arranged will be referred to as a “horizontal direction”, and a perpendicular direction to the front surface 1A of the power supply substrate 1 will be referred to as a “vertical direction”. The axial direction, horizontal direction, and vertical direction are mutually orthogonal directions extending along three orthogonal axes. Further, in the vertical direction, as shown in FIG. 1, the bus bar unit 2 side will be referred to as “downward”, and the terminal guide 9 side will be referred to as “upward”.

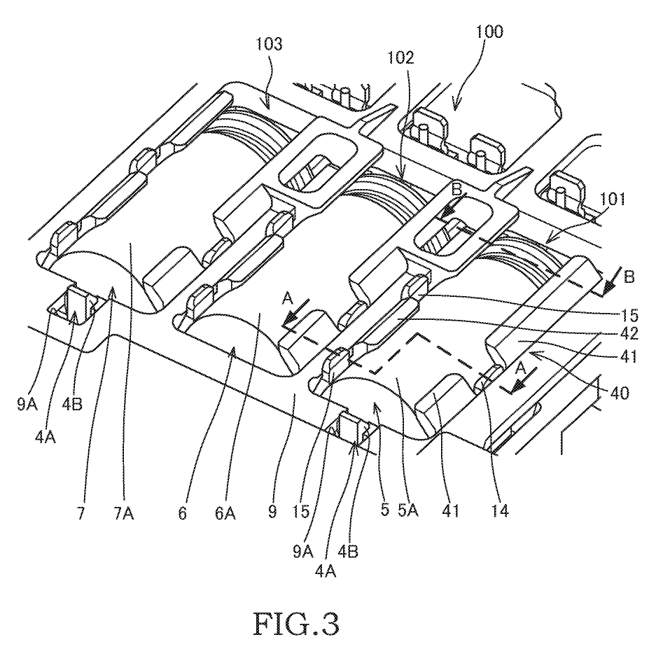

As shown in FIG. 3, the electronic component holder 100 includes first, second, and third holder portions 101, 102, 103 for holding the three electrolytic capacitors 5, 6, 7, respectively. The first, second, and third holder portions 101, 102, 103 have similar configurations. Therefore, the configuration of the first holder portion 101 will mainly be described below, and description of the configurations of the second and third holder portions 102, 103 will be omitted where appropriate. Furthermore, the first holder portion 101 will be referred to simply as “the holder portion 101” hereafter.

As shown in FIGS. 2 to 4, the holder portion 101 includes a clip portion 11 that is provided on the bus bar unit 2 and formed to be capable of expanding and contracting so as to accommodate the electrolytic capacitor 5 while gripping the outer peripheral surface 5A of the electrolytic capacitor 5, a restricting portion 30 provided on the terminal guide 9 and latched to the clip portion 11 to prevent the clip portion 11 from separating from the outer peripheral surface 5A of the electrolytic capacitor 5, and an abutting portion 40 provided on the terminal guide 9 so as to abut the outer peripheral surface 5A of the electrolytic capacitor 5 from the vertical direction, i.e. the direction in which the terminal guide 9 is attached to and detached from the bus bar unit 2. In this embodiment, the bus bar unit 2 corresponds to a first member, and the terminal guide 9 corresponds to a second member.

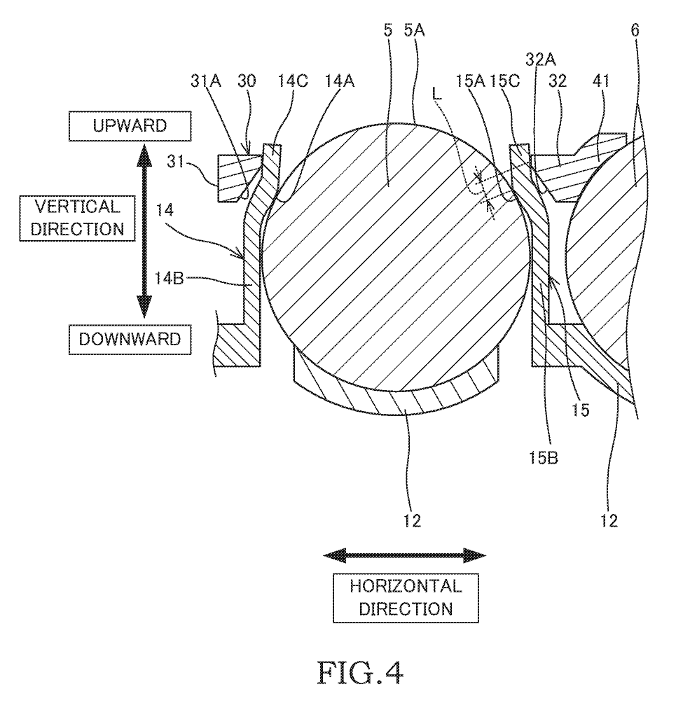

As shown in FIG. 2, the clip portion 11 is formed integrally with the covering portion 4 molded to the plurality of terminals 3. In other words, the clip portion 11 is formed using the resin material constituting the covering portion 11. As shown in FIGS. 2 and 4, the clip portion 11 includes a support portion 12 for supporting the electrolytic capacitor 5, and a plurality of pawl portions 13 formed to extend in the circumferential direction of the electrolytic capacitor 5.

As shown in FIG. 4, the support portion 12 is formed to cover a part of the outer peripheral surface 5A of the electrolytic capacitor 5 on the vertical direction downward side. In other words, the support portion 12 contacts a part of the outer peripheral surface 5A of the electrolytic capacitor 5 that is downward of the central axis in the vertical direction.

As shown in FIG. 2, the plurality of pawl portions 13 are provided on both horizontal direction sides of the central axis of the electrolytic capacitor 5 in order to grip the electrolytic capacitor 5. More specifically, the plurality of pawl portions 13 include a single first pawl portion 14 provided on one side of the central axis of the electrolytic capacitor 5, and two second pawl portions 15 provided on the other side.

The first pawl portion 14 and the second pawl portions 15 are provided alternately on either side of the electrolytic capacitor 5 so as to face each other. The two second pawl portions 15 are provided via an interval in the axial direction. The first pawl portion 14 is provided such that an axial direction position thereof is between the two second pawl portions 15. Further, in the first to third holder portions 101, 102, 103, the first pawl portions 14 respectively contacting the three electrolytic capacitors 5, 6, 7 are provided such that the axial direction positions thereof are substantially aligned. The second pawl portions 15 respectively contacting the three electrolytic capacitors 5, 6, 7 are likewise provided such that the axial direction positions thereof are substantially aligned. In other words, the first pawl portion 14 of the second holder 102 is disposed between the two second pawl portions 15 of the first holder 101 in the axial direction.

By disposing the first pawl portion 14 and the second pawl portions 15 alternately in this manner, a distance between adjacent electrolytic capacitors 5, 6, 7 need only be sufficient to secure the thickness of one set of the first pawl portion 14 and the second pawl portions 15, and as a result, space can be saved. Further, by disposing the first pawl portion 14 and the second pawl portions 15 alternately, the electrolytic capacitors 5, 6, 7 can be gripped along the entire axial direction length thereof by a small number of pawl portions 13. It should be noted that the first pawl portion 14 and the second pawl portions 15 do not have to be disposed alternately. Moreover, in the first to third holder portions 101, 102, 103, the respective axial direction positions of the first pawl portion 14 and the second pawl portions 15 may deviate from each other.

As shown in FIG. 4, the first pawl portion 14 and the second pawl portions 15 respectively include arm portions 14B, 15B that are formed from the covering portion 4 and have contact portions 14A, 15A that contact the cylindrical outer peripheral surface 5A of the electrolytic capacitor 5, and projecting portions 14C, 15C that are formed from the contact portions 14A, 15A and separate from the outer peripheral surface 5A of the electrolytic capacitor 5 so as to form respective free ends of the first pawl portion 14 and the second pawl portions 15. In other words, in the first pawl portion 14 and the second pawl portions 15, the arm portions 14B, 15B serve as base end sides connected to the covering portion 4, and the projecting portions 14C, 15C serve as free ends. The contact portions 14A, 15A correspond to boundary parts between the arm portions 14B, 15B and the projecting portions 14C, 15C.

The arm portions 14B, 15B are formed to extend in the circumferential direction of the electrolytic capacitor 5 upward of the central axis of the electrolytic capacitor 5 in the vertical direction, and respective end portions thereof (parts that form boundaries with the projecting portions 14C, 15C) contact the electrolytic capacitor 5 as the contact portions 14A, 15A. In other words, the contact portions 14A, 15A contact the outer peripheral surface 5A of the electrolytic capacitor 5 upward of the central axis of the electrolytic capacitor 5 in the vertical direction. As a result, the electrolytic capacitor 5 is gripped from a radial direction by the contact portions 14A, 15A of the first and second pawl portions 14, 15, which contact the electrolytic capacitor 5 upward of the central axis in the vertical direction, and the support portion 12, which contacts the electrolytic capacitor 5 downward of the central axis in the vertical direction.

The projecting portions 14C, 15C are formed to extend away from the electrolytic capacitor 5 upward in the vertical direction from the contact portions 14A, 15A of the arm portions 14B, 15B. A horizontal direction interval between the projecting portion 14C of the first pawl portion 14 and the projecting portions 15C of the second pawl portions 15 is smaller than a diameter of the electrolytic capacitor 5. The plurality of pawl portions 13 are formed to be capable of expanding and contracting so that the horizontal direction interval between the projecting portion 14C of the first pawl portion 14 and the projecting portions 15C of the second pawl portions 15 varies and the arm portions 14B, 15B serving as the base end sides bend from the bases thereof.

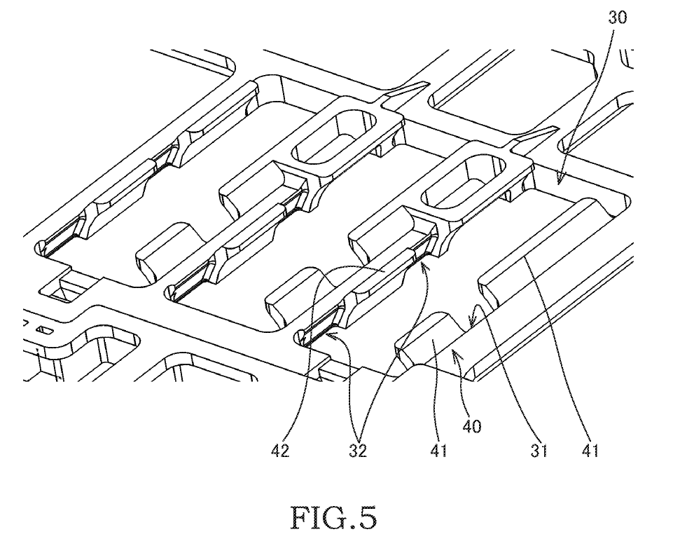

As shown in FIGS. 4 and 5, the restricting portion 30 includes a first restricting portion 31 that contacts the first pawl portion 14, and second restricting portions 32 that respectively contact the second pawl portions 15. As shown in FIG. 4, the first restricting portion 31 and the second restricting portions 32 are respectively provided at a remove from, i.e. not in contact with, the arm portions 14B, 15B of the first pawl portion 14 and the second pawl portions 15.

The first restricting portion 31 and the second restricting portions 32 respectively include tapered portions 31A, 32A that gradually taper outwardly in the horizontal direction from the central axis of the electrolytic capacitor 5 toward the bus bar unit 2 on the downward side in FIG. 4. In other words, the restricting portion 30 is formed such that a horizontal direction interval between the first restricting portion 31 and the second restricting portions 32 gradually increases downward in the vertical direction toward the bus bar unit 2.

In a free condition before attaching the bus bar unit 2 and the terminal guide 9, when the first restricting portion 31 and second restricting portions 32 are not in contact with the first pawl portion 14 and the second pawl portions 15, the horizontal direction interval between the first restricting portion 31 and the second restricting portions 32 on the vertical direction upward side is set to be smaller than an interval between horizontal direction outer side end surfaces of the projecting portions 14C, 15C. Hence, when the bus bar unit 2 and the terminal guide 9 are attached such that the first restricting portion 31 and second restricting portions 32 contact the first pawl portion 14 and the second pawl portions 15, the first restricting portion 31 and the second restricting portions 32 contact the projecting portions 14C, 15C of the first pawl portion 14 and the second pawl portions 15 in positions removed from the contact portions 14A, 15A upward in the vertical direction. As a result, the projecting portions 14C, 15C are pressed toward the central axis of the electrolytic capacitor 5 by the first restricting portion 31 and the second restricting portions 32. Accordingly, expansion of the first pawl portion 14 and the second pawl portions 15, by which the first pawl portion 14 and the second pawl portions 15 move outwardly in the horizontal direction (an expansion/contraction direction) from the central axis of the electrolytic capacitor 5, is restricted by the restricting portion 30. Further, the first restricting portion 31 and the second restricting portions 32 press the projecting portions 14C, 15C of the first pawl portion 14 and the second pawl portions 15 toward the central axis of the electrolytic capacitor 5 using the contact portions 14A, 15A as a fulcrum, and therefore a moment arm length L (see FIG. 4) of a force for restricting separation of the contact portions 14A, 15A from the electrolytic capacitor 5 can be increased. Hence, the first pawl portion 14 and the second pawl portions 15 remain in contact with the outer peripheral surface 5A of the electrolytic capacitor 5, and therefore release of the grip exerted by the clip portion 11 due to vibration or the like can be prevented more reliably. As a result, the electrolytic capacitor 5 can be fixed reliably.

As shown in FIGS. 3 and 5, the abutting portion 40 includes two first abutting portions 41 provided on one horizontal direction side of the electrolytic capacitor 5, and a single second abutting portion 42 provided on the other horizontal direction side of the electrolytic capacitor 5.

As shown in FIG. 3, the first abutting portions 41 are provided on either side of the first pawl portion 14 in the axial direction. The second abutting portion 42 is provided such that an axial direction position thereof is between the second pawl portions 15. In other words, the first pawl portion 14 and the second abutting portion 42 are disposed in mutually opposing positions on either side of the electrolytic capacitor 5, and the second pawl portions 15 and the first abutting portions 41 are disposed in mutually opposing positions on either side of the electrolytic capacitor 5.

As shown in FIGS. 2 and 6, the electronic component holder 100 further includes a latch hole 50 formed in the covering portion 4 of the power supply substrate 1, an opposing portion 51 provided opposite the latch hole 50, and a latch portion 52 (see FIG. 6) latched across the indented portions 5B, 6B of the electrolytic capacitors 5, 6 and the latch hole 50.

As shown in FIG. 2, the latch hole 50 is formed in a position between the adjacent electrolytic capacitors 5, 6 in the horizontal direction such that an axial direction position thereof is substantially aligned with the indented portions 5B, 6B of the electrolytic capacitors 5, 6. In other words, the latch hole 50 is provided to face the respective indented portions 5B, 6B of the adjacent electrolytic capacitors 5, 6. It should be noted that the latch hole 50 does not have to be provided in a position where the axial direction position thereof is substantially aligned with the indented portions 5B, 6B of the electrolytic capacitors 5, 6, and may be provided in any desired position as long as the latch portion 52, to be described below, can be formed.

The opposing portion 51 is provided between the adjacent electrolytic capacitors 5, 6. The opposing portion 51 is formed substantially in a U shape such that respective ends thereof are connected to the covering portion 4 on respective axial direction sides of the latch hole 50, and a central portion thereof opposes the latch hole 50.

The latch portion 52 is formed from a thermoplastic material (a hot melt resin such as polyamide or polypropylene, for example) that possesses fluidity and hardens as the temperature thereof decreases over time. As shown in FIG. 6, the latch portion 52 is latched to the latch hole 50 and the opposing portion 51, and charged into respective parts of the indented portions 5B, 6B of the electrolytic capacitors 5, 6. When the latch portion 52 is charged into the indented portions 5B, 6B so as to be latched thereto, the electrolytic capacitors 5, 6 are held thereby such that movement thereof in the axial direction is restricted. Further, the latch portion 52 is provided to cover the outer peripheral surfaces 5A, 6A of the electrolytic capacitors 5, 6 across the respective central axes of the electrolytic capacitors 5, 6 in the vertical direction. As a result, the latch portion 52 also restricts movement of the electrolytic capacitors 5, 6 in the vertical direction and the horizontal direction.

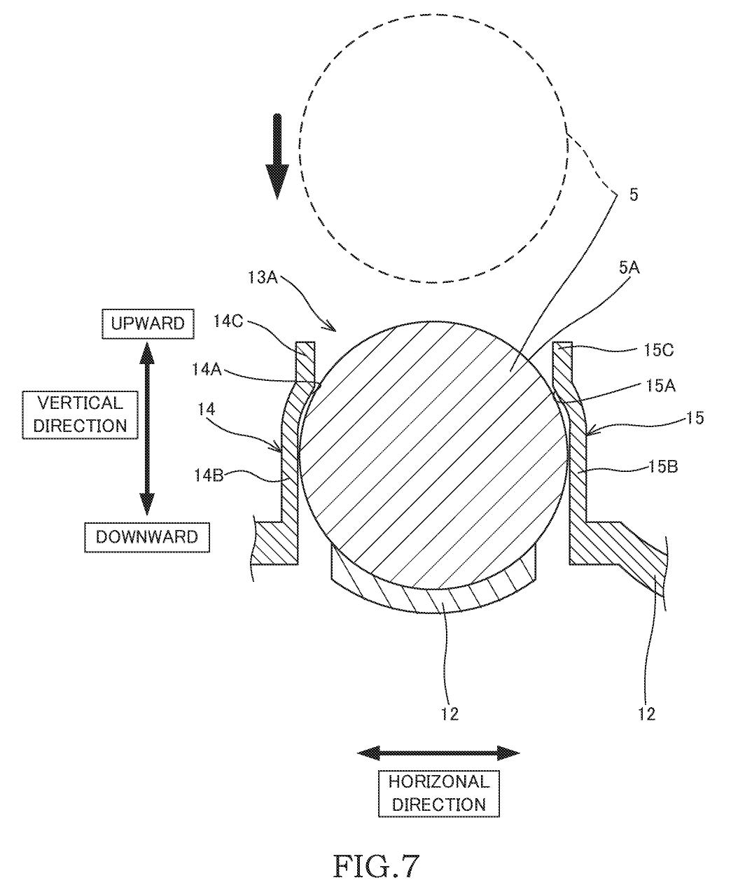

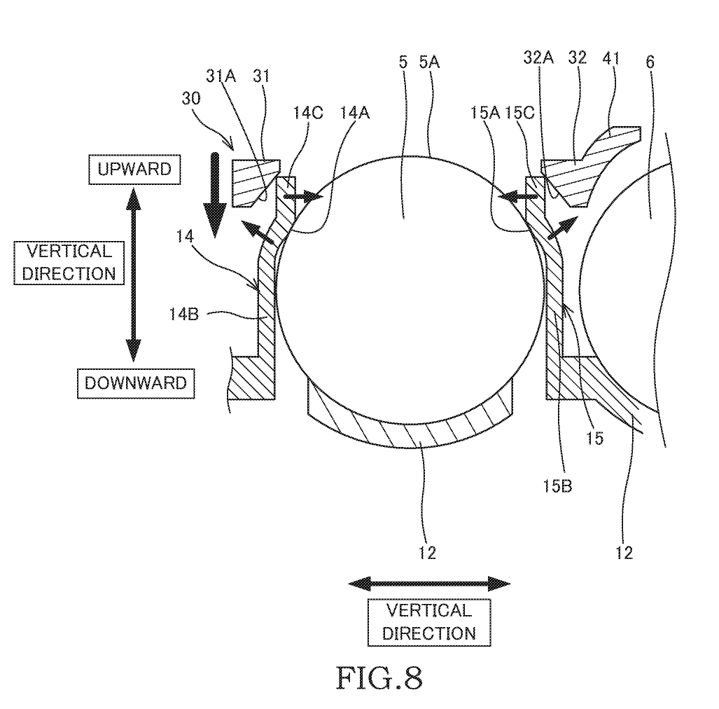

Next, referring mainly to FIGS. 7 and 8, a method of assembling the electronic control device 10 will be described. As above, description of the electrolytic capacitors 6, 7 will be omitted below where appropriate.

First, the electrolytic capacitor 5 is attached to the clip portion 11 provided on the bus bar unit 2. More specifically, as shown in FIG. 7, the electrolytic capacitor 5 is inserted into an opening portion 13A formed by the projecting portions 14C, 15C of the first pawl portion 14 and the second pawl portions 15 while causing the first pawl portion 14 and the second pawl portions 15 to expand, and is thereby accommodated on respective inner sides of the first pawl portion 14 and the second pawl portions 15. It should be noted that in this condition, the contact portions 14A, 15A provided on the arm portions 14B, 15B of the first pawl portion 14 and the second pawl portions 15 do not contact the outer peripheral surface 5A of the electrolytic capacitor 5, and are provided at a slight gap relative thereto.

Next, the perpendicular portions 8B of the pair of leads 8 of the electrolytic capacitor 5 are welded respectively to the corresponding terminals 3 so as to be electrically connected thereto (see FIG. 2).

Next, the terminal guide 9 is attached to the bus bar unit 2. More specifically, the hook portions 4A provided on the bus bar unit 2 are inserted through the hook holes 9A formed in the terminal guide 9, whereupon the terminal guide 9 is lowered downward in the vertical direction so that the hook pawls 4B on the tip ends of the hook portions 4A engage with the terminal guide 9.

As the terminal guide 9 is attached to the bus bar unit 2, the plurality of pawl portions 13 are inserted into the inner side of the restricting portion 30. More specifically, as shown in FIG. 8, as the terminal guide 9 is lowered, the projecting portions 14C, 15C of the first pawl portion 14 and the second pawl portions 15 are pressed toward the central axis of the electrolytic capacitor 5 by the corresponding first restricting portion 31 and second restricting portions 32 while being guided by the tapered portions 31A, 32A of the first restricting portion 31 and the second restricting portions 32. Once the projecting portions 14C, 15C of the first pawl portion 14 and the second pawl portions 15 have been inserted by a predetermined amount into the inner sides of the first restricting portion 31 and the second restricting portions 32 while being guided by the tapered portions 31A, 32A, the contact portions 14A, 15A of the arm portions 14B, 15B contact the outer peripheral surface 5A of the electrolytic capacitor 5 (the condition shown in FIG. 8).

When the terminal guide 9 is lowered further from this condition, the first restricting portion 31 and the second restricting portions 32 press the projecting portions 14C, 15C inwardly toward the central axis of the electrolytic capacitor 5 using the contact portions 14A, 15A as fulcrums. Accordingly, the arm portions 14B, 15B deform from the bases (base end sides) thereof and, as shown by arrows in FIG. 8, deform so as to expand outwardly in the radial direction. As a result, a condition in which the clip portion 11 is contracted and the pawl portions 13 and restricting portion 30 are latched is established (the condition shown in FIG. 4). At this time, the deformed arm portions 14B, 15B are configured not to contact the tapered portions 31A, 32A of the restricting portion 30. Since the arm portions 14B, 15B do not contact the tapered portions 31A, 32A, the tapered portions 31A, 32A do not prevent deformation of the arm portions 14B, 15B, and therefore a situation in which the first restricting portion 31 and the second restricting portions 32 are prevented from pressing the projecting portions 14C, 15C further does not occur. As a result, the terminal guide 9 can be attached reliably to the bus bar unit 2.

Hence, by gripping the electrolytic capacitor 5 using the clip portion 11 and preventing the clip portion 11 from separating from the electrolytic capacitor 5 using the restricting portion 30 in this manner, the grip exerted on the electrolytic capacitor 5 by the clip portion 11 is maintained. As a result, the electrolytic capacitor 5 is fixed to the bus bar unit 2 by the electronic component holder 100 more reliably.

Further, the bus bar unit 2 and the terminal guide 9 are prevented from becoming detached from each other by the hook portions 4A. More specifically, as shown in FIG. 1, the hook portions 4A are preferably provided in positions adjacent to the electrolytic capacitors 5, 6, 7, or in other words on the periphery of the electrolytic capacitors 5, 6, 7. In so doing, a situation in which the bus bar unit 2 and the terminal guide 9 become detached from each other due to a disturbance such as vibration such that the latch between the restricting portion 30 and the clip portion 11 is released, whereby the clip portion 11 can no longer be prevented from separating from the electrolytic capacitors 5, 6, 7 such that the electrolytic capacitors 5, 6, 7 fall out, can be effectively prevented from occurring.

Furthermore, before the terminal guide 9 is attached to the bus bar unit 2, the contact portions 14A, 15A do not contact the outer peripheral surface 5A of the electrolytic capacitor 5 (see FIG. 7), but when the terminal guide 9 is attached to the bus bar unit 2, the first restricting portion 31 and the second restricting portions 32 press the projecting portions 14C, 15C such that the contact portions 14A, 15A come into contact with the outer peripheral surface 5A of the electrolytic capacitor 5 (see FIG. 8). In other words, the horizontal direction interval between the projecting portions 14C, 15C of the first pawl portion 14 and the second pawl portions 15 in a condition where the projecting portions 14C, 15C are in contact with the first restricting portion 31 and the second restricting portions 32 is smaller than the horizontal direction interval in a condition where the projecting portions 14C, 15C are not in contact with the first restricting portion 31 and the second restricting portions 32. By having the first restricting portion 31 and the second restricting portions 32 press the projecting portions 14C, 15C in this manner, the contact portions 14A, 15B can be brought into contact with the outer peripheral surface 5A of the electrolytic capacitor 5 reliably, even when an outer diameter dimension of the electrolytic capacitor 5 varies due to dimensional tolerance or the like.

Moreover, when the terminal guide 9 is attached to the bus bar unit 2, the abutting portion 40 provided on the terminal guide 9 abuts the outer peripheral surface 5A of the electrolytic capacitor 5 from the vertical direction upward side. Hence, in addition to the grip exerted on the electrolytic capacitor 5 by the clip portion 11 and the restricting portion 30, the electrolytic capacitor 5 is gripped in the radial direction by the support portion 12 and the abutting portion 40. As a result, the electrolytic capacitor 5 is fixed to the bus bar unit 2 even more reliably.

Next, the latch portion 52 is formed by applying the thermoplastic material toward the electrolytic capacitor 5 through the latch hole 50. More specifically, first, an assembly including the bus bar unit 2 and the terminal guide 9 is turned upside-down so that the opposing portion 51 is positioned downward of the latch hole 50 in the vertical direction. In this condition, the thermoplastic material is injected through the latch hole 50. The injected thermoplastic material is prevented from dripping downward by the opposing portion 51, and therefore flows into the indented portions 5B, 6B of the electrolytic capacitors 5, 6. As a result, the thermoplastic material is charged into the indented portions 5B, 6B. The thermoplastic material applied to the electrolytic capacitor 5 in this manner decreases in temperature over time, leading to a reduction in the fluidity thereof, and thus the thermoplastic material hardens. As a result, as shown in FIG. 6, the latch portion 52 is formed so as to be latched across the indented portions 5B, 6B of the electrolytic capacitors 5, 6 and the latch hole 50.

Next, the assembly of the bus bar unit 2 and the terminal guide 9 is turned the right way up, and then attached to the power supply substrate 1. Further, the control substrate is attached by lowering the control substrate from above onto an assembly including the power supply substrate 1, the bus bar unit 2, and the terminal guide 9, and then pressing the control substrate so as to seat the control substrate on the terminal guide 9.

Next, an assembly including the power supply substrate 1, the bus bar unit 2, the terminal guide 9, and the control substrate is attached to the interior of a housing (not shown), whereby assembly of the electronic control device 10 is complete.

Here, when the outer peripheral surface 5A of the electrolytic capacitor 5 exhibits poor adhesiveness, it is generally difficult to fix a main body part of the electrolytic capacitor 5 to the bus bar unit 2 using an adhesive. In this case, the electrolytic capacitor 5 may be fixed using an adhesive by fixing the pair of leads 8 to the bus bar unit 2 using an adhesive.

However, when a method of fixing the leads 8 using an adhesive is employed and vibration or the like acts thereon, the electrolytic capacitor 5 may vibrate using the fixed leads 8 as a fulcrum. More specifically, in a case where the control subject of the electronic control device 10 is an engine or an electric power steering device or the like so that the electronic control device 10 is mounted in a vehicle, on which vibration is likely to act, the likelihood of the electrolytic capacitor 5 vibrating increases. When the electrolytic capacitor 5 vibrates in this manner, the leads 8 may bend, leading to a reduction in the durability of the leads 8.

In this embodiment, however, the outer peripheral surface 5A of the electrolytic capacitor 5 is fixed mechanically to the bus bar unit 2 by the electronic component holder 100. Hence, the electrolytic capacitor 5 can be fixed reliably even when the outer peripheral surface 5A of the electrolytic capacitor 5 exhibits poor adhesiveness and cannot easily be fixed using an adhesive.

Furthermore, the clip portion 11 grips the electrolytic capacitor 5 from the radial direction, and therefore a force for restricting axial direction vibration is smaller than a force for restricting horizontal direction and vertical direction vibration. However, the electronic component holder 100 includes the latch portion 52 that is latched through the latch hole 50, or in other words across the covering portion 4 of the bus bar unit 2, and the indented portions 5B, 6B of the electrolytic capacitors 5, 6, and therefore axial direction movement of the electrolytic capacitor 5 is restricted by the latch portion 52. Accordingly, axial direction movement of the electrolytic capacitor 5 can be restricted more reliably, and as a result, the electrolytic capacitor 5 can be fixed more reliably. It should be noted that when axial direction movement of the electrolytic capacitor 5 can be sufficiently restricted by the clip portion 11, the latch portion 52 need not be provided. In other words, the electronic component holder 100 does not necessarily have to include the latch portion 52.

Next, modified examples of this embodiment will be described.

In the above embodiment, axial direction movement of the electrolytic capacitor 5 is restricted by latching the latch portion 52 to the indented portions 5B, 6B of the electrolytic capacitors 5, 6. When the perpendicular portion 8B of the lead 8 of the electrolytic capacitor 5 is connected to the terminal 3 extending vertically (i.e. extending in a direction parallel to the perpendicular portion 8B), the perpendicular portion 8B and the terminal 3 must be positioned so as to eliminate a distance therebetween in the axial direction in order to weld the two components together, and as a result, axial direction positions of the indented portions 5B, 6B are likely to vary. In this case, since the latch portion 52 is formed from a thermoplastic material possessing fluidity and therefore does not require positioning, axial direction movement of the electrolytic capacitor 5 is preferably restricted by forming the latch portion 52 after welding the lead 8 to the terminal 3. Alternatively, the latch portion 52 may be omitted, and one of the first pawl portion 14 and the second pawl portions 15 may be engaged with the indented portions 5B, 6B. More specifically, in a case where the lead 8 does not include the perpendicular portion 8B so that the parallel portion 8A of the lead 8 is welded to the terminal 3 extending in the horizontal direction, there is no need to position the electrolytic capacitor 5 relative to the terminal for the purpose of welding, and therefore the first pawl portion 14 or the second pawl portion 15 can be engaged with the indented portions 5B, 6B more easily by aligning the respective positions of the indented portions 5B, 6B and the first pawl portion 14 or second pawl portion 15. Hence, in this case, axial direction movement of the electrolytic capacitor 5 can be restricted without forming the latch portion 52, and as a result, manufacturing costs can be reduced.

Further, in the above embodiment, the latch portion 52 is filled into the indented portions 5B, 6B of the electrolytic capacitors 5, 6 and formed in the vertical direction so as to extend across the central axis in the vertical direction. Alternatively, the latch portion 52 may be formed only on the vertical direction downward side of the central axis. In this case, the latch portion 52 cannot restrict vertical direction movement of the electrolytic capacitor 5 but can restrict axial direction movement of the electrolytic capacitor 5.

Furthermore, in the above embodiment, in a condition where the pawl portions 13 are not latched to the restricting portion 30 (see FIG. 7), the contact portions 14A, 15A of the first pawl portion 14 and the second pawl portions 15 do not contact the outer peripheral surface 5A of the electrolytic capacitor 5, but the present invention is not limited thereto, and the contact portions 14A, 15A of the first pawl portion 14 and the second pawl portions 15 may contact the outer peripheral surface 5A of the electrolytic capacitor 5. The outer diameter dimension of the electrolytic capacitor 5 may vary due to tolerance and so on, but in a condition where the pawl portions 13 and the restricting portion 30 are not latched, the contact portions 14A, 15A and the outer peripheral surface 5A of the electrolytic capacitor 5 may either contact each other or not contact each other. Either case may be employed, provided that when the pawl portions 13 are latched to the restricting portion 30, the first restricting portion 31 and the second restricting portions 32 press the projecting portions 14C, 15C so that the contact portions 14A, 15A contact the outer peripheral surface 5A of the electrolytic capacitor 5.

Moreover, in the above embodiment, the electronic component holder 100 holds the electrolytic capacitor 5 as a cylindrical electronic component. However, the electronic component holder 100 may hold an electronic component known as a choke coil, which is formed by winding a wire material around a cylindrical shaft portion, for example.

Further, in the above embodiment, the clip portion 11 is formed integrally with the covering portion 4 of the bus bar unit 2, and the restricting portion 30 is formed integrally with the terminal guide 9. In other words, in the above embodiment, the covering portion 4 and a part of the terminal guide 9 constitute the electronic component holder 100. Instead, however, the electronic component holder 100 may include a first member provided with the clip portion 11 and formed separately to the bus bar unit 2, and a second member provided with the restricting portion 30 and formed separately to the terminal guide 9. In this case, the first member should be attached to the bus bar unit 2, and the second member should be attached to the terminal guide 9.

With the embodiment described above, the following effects are obtained.

In the electronic component holder 100, the clip portion 11 grips the electrolytic capacitor 5 and the restricting portion 30 prevents the electrolytic capacitor 5 and the clip portion 11 from separating from each other. Therefore, the electrolytic capacitor 5 can be fixed to the bus bar unit 2 regardless of the adhesiveness of the outer peripheral surface 5A of the electrolytic capacitor 5. As a result, the electrolytic capacitor 5 provided in the electronic control unit 10 is fixed more reliably.

Further, before the terminal guide 9 is attached to the bus bar unit 2, the contact portions 14A, 15A do not contact the outer peripheral surface 5A of the electrolytic capacitor 5, but when the terminal guide 9 is attached to the power supply substrate 1, the restricting portion 30 presses the projecting portions 14C, 15C such that the contact portions 14A, 15A press the outer peripheral surface 5A of the electrolytic capacitor 5. As a result, the contact portions 14A, 15A can be brought into contact with the outer peripheral surface 5A of the electrolytic capacitor 5 reliably even when the outer diameter dimension of the electrolytic capacitor 5 varies due to dimensional tolerance or the like.

Furthermore, the electronic component holder 100 includes the latch portion 52 that is latched across the latch hole 50 and the indented portions 5B, 6B of the electrolytic capacitors 5, 6, and therefore axial direction movement of the electrolytic capacitor 5 is restricted by the latch portion 52. Hence, axial direction movement of the electrolytic capacitor 5 can be restricted reliably, and as a result, the electrolytic capacitor 5 can be fixed even more reliably.

The configurations, actions, and effects of the embodiments of the present invention are summarized below.

The electronic component holder 100 for holding the cylindrical electrolytic capacitors 5, 6, 7 provided in the electronic control device 10 includes the clip portion 11 that is formed to be capable of expanding and contracting and accommodates the electrolytic capacitors 5, 6, 7 while gripping the outer peripheral surfaces 5A, 6A, 7A of the electrolytic capacitors 5, 6, 7, and the restricting portion 30 that is latched to the clip portion 11 to prevent the clip portion 11 from separating from the outer peripheral surfaces 5A, 6A, 7A of the electrolytic capacitors 5, 6, 7.

With this configuration, the clip portion 11 grips the electrolytic capacitors 5, 6, 7 and the restricting portion 30 prevents the clip portion 11 from separating from the electrolytic capacitors 5, 6, 7, and therefore the main body parts of the electrolytic capacitors 5, 6, 7 can be fixed regardless of the adhesiveness of the outer peripheral surfaces 5A, 6A, 7A of the electrolytic capacitors 5, 6, 7. As a result, the electrolytic capacitors 5, 6, 7 provided in the electronic control unit are fixed more reliably.

Further, in the electronic component holder 100, the clip portion 11 includes the plurality of pawl portions 13 provided on the respective sides of the central axes of the electrolytic capacitors 5, 6, 7, the pawl portions 13 include the arm portions 14B, 15B formed with the contact portions 14A, 14B that contact the outer peripheral surfaces 5A, 6A, 7A of the electrolytic capacitors 5, 6, 7 and the projecting portions 14C, 15C formed from the contact portions 14A, 15A so as to separate from the outer peripheral surfaces 5A, 6A, 7A of the electrolytic capacitors 5, 6, 7, and the restricting portion 30 presses the projecting portions 14C, 15C in the horizontal direction in which the clip portion 11 is caused to contract.

With this configuration, even when the outer diameters of the electrolytic capacitors 5, 6, 7 vary, the projecting portions 14C, 15C are pressed toward the central axis by the restricting portion 30, and therefore the contact portions 14A, 15A can be brought into contact with the outer peripheral surfaces 5A, 6A, 7A of the electrolytic capacitors 5, 6, 7 reliably. As a result, the electrolytic capacitors 5, 6, 7 can be fixed even more reliably.

Furthermore, in the electronic component holder 100, the first restricting portion 31 and the second restricting portions 32 press the projecting portions 14C, 15C using the contact portions 14A, 15A as a fulcrum.

With this configuration, the moment arm length L of the force applied by the first restricting portion 31 and the second restricting portions 32 to restrict separation of the contact portions 14A, 15A from the electrolytic capacitors 5, 6, 7 can be increased. As a result, release of the grip exerted by the clip portion 11 can be prevented even more reliably.

Furthermore, in the electronic component holder 100 for holding the three electrolytic capacitors 5, 6, 7 having central axes that are arranged in parallel with each other, the plurality of pawl portions 13 include the first pawl portion 14 provided on one side of the central axis of each of the electrolytic capacitors 5, 6, 7, and the second pawl portions 15 provided on the other side, and the first pawl portion 14 and the second pawl portions 15 are disposed alternately in the direction of the central axis.

According to this configuration, the interval between adjacent electrolytic capacitors 5, 6, 7 can be set at the thickness of one set of the first pawl portion 14 and the second pawl portions 15, and as a result, space can be saved in the electronic component holder 100.

Moreover, the electronic component holder 100 further includes the bus bar unit 2 and the terminal guide 9, which are constituted to be mutually attachable and detachable, and the clip portion 11 is provided on the bus bar unit 2 while the restricting portion 30 is provided on the terminal guide 9.

Moreover, the electronic component holder 100 further includes the abutting portion 40 that is provided on the terminal guide 9 together with the restricting portion 30 and abuts each of the electrolytic capacitors 5, 6, 7 in a condition where the bus bar unit 2 and the terminal guide 9 are attached to each other.

With this configuration, when the abutting portion 40 abuts each of the electrolytic capacitors 5, 6, 7, movement of the electrolytic capacitor 5, 6, 7 in an attachment/detachment direction can be prevented, and as a result, the electrolytic capacitors 5, 6, 7 can be fixed even more reliably.

Furthermore, in the electronic component holder 100, the first member is the bus bar unit 2, in which the terminals 3 are covered by the covering portion 4 formed from a resin material, and the clip portion 11 is formed integrally with the covering portion 4 from the resin material.

According to this configuration, the clip portion 11 is formed integrally with the covering portion 4, and can therefore be formed easily, leading to a reduction in manufacturing costs.

Moreover, the electronic component holder 100 further includes the hook portions 4A for engaging the bus bar unit 2 and the terminal guide 9 with each other and preventing the bus bar unit 2 and the terminal guide 9 from becoming detached.

According to this configuration, the bus bar unit 2 and the terminal guide 9 are prevented from becoming detached by the hook portions 4A, and therefore release of the latch between the restricting portion 30 and the clip portion 11 is prevented.

Furthermore, in the electronic component holder 100, the contact portions 14A, 15A of the pawl portions 13 contact the indented portions 5B, 6B, 7B formed in the outer peripheral surfaces 5A, 6A, 7A of the electrolytic capacitors 5, 6, 7.

According to this configuration, the pawl portions 13 are latched to the indented portions 5B, 6B, 7B, and as a result, axial direction movement of the electrolytic capacitors 5, 6, 7 is restricted.

Moreover, the electronic component holder 100 further includes the latch hole 50 provided in the covering portion 4 of the bus bar unit 2, and the latch portion 52 that is latched across the indented portions 5B, 6B, 7B formed in the outer peripheral surfaces 5A, 6A, 7A of the electrolytic capacitors 5, 6, 7 and the latch hole 50 in order to position the electrolytic capacitors 5, 6, 7 in the axial direction relative to the bus bar unit 2.

With this configuration, the electrolytic capacitors 5, 6, 7 can be positioned in the axial direction by the latch portion 52 even when the force of the clip portion 11 for restricting axial direction movement of the electrolytic capacitors 5, 6, 7 is insufficient, and as a result, the electrolytic capacitors 5, 6, 7 can be fixed even more reliably.

Embodiments of this invention were described above, but the above embodiments are merely examples of applications of this invention, and the technical scope of this invention is not limited to the specific constitutions of the above embodiments.

This application claims priority based on Japanese Patent Application No. 2015-254439 filed with the Japan Patent Office on Dec. 25, 2015, the entire contents of which are incorporated into this specification.

1. An electronic component holder for holding a cylindrical electronic component provided in an electronic control device, comprising:
a clip portion formed to be capable of expanding and contracting and accommodates the electronic component while gripping an outer peripheral surface of the electronic component; and
a restricting portion configured to be latched to the clip portion to prevent the clip portion from separating from the outer peripheral surface of the electronic component,
wherein the clip portion includes a plurality of pawl portions provided on respective sides of a central axis of the component holder,
each of the pawl portions includes:
an arm portion formed with a contact portion that contacts the outer peripheral surface of the electronic component; and
a projecting portion formed from the contact portion so as to separate from the outer peripheral surface of the electronic component, and
the restricting portion includes a tapered portion that is configured to press the projecting portion in a direction for causing the clip portion to contract while guiding the projecting portion.

2. (canceled)

3. The electronic component holder as defined in claim 1, wherein the restricting portion is configured to press the projecting portion using the contact portion as a fulcrum.

4. The electronic component holder as defined in claim 1, for holding a plurality of the electronic components having central axes arranged in parallel with each other, wherein the plurality of pawl portions include a first pawl portion provided on one side of the central axis of the electronic component, and a second pawl portion provided on the other side, and
the first pawl portion and the second pawl portion are disposed alternately in a direction of the central axis.

5. The electronic component holder as defined in claim 1, further comprising a first member and a second member constituted to be mutually attachable and detachable, wherein the clip portion is provided on the first member, and the restricting portion is provided on the second member.

6. The electronic component holder as defined in claim 5, for holding a plurality of the electronic components having central axes arranged in parallel with each other, comprising a plurality of holder portions for respectively holding the electronic components, wherein each of the holder portions includes:
the clip portion;
the restricting portion; and
an abutting portion that is provided on the second member together with the restricting portion and is configured to abut the electronic component in a condition where the first member and the second member are attached, and
the abutting portion has an identical position in an axial direction of the electronic component to the pawl portions of the clip portion of the adjacent holder portion, and is provided continuously with the pawl portions in a direction perpendicular to the axial direction.

7. The electronic component holder as defined in claim 5, wherein the first member is a bus bar unit in which a terminal is covered by a covering portion formed from a resin material, and
the clip portion is formed integrally with the covering portion from the resin material.

8. The electronic component holder as defined in claim 5, further comprising a fixing portion for engaging the first member and the second member with each other and preventing the first member and the second member from becoming detached.

9. The electronic component holder as defined in claim 5, further comprising:
a latch hole provided in the first member; and
a latch portion configured to be latched across an indented portion formed in the outer peripheral surface of the electronic component and the latch hole in order to position the electronic component in an axial direction relative to the first member,
wherein the latch portion is a thermoplastic material that possesses fluidity and hardens over time.

10. The electronic component holder as defined in claim 1, wherein the contact portion of the pawl portion is engaged with an indented portion formed in the outer peripheral surface of the electronic component.
